(19) United States
(12) Patent Application Publication
(10) Pub. No.: US 2002/0031225 A1
(43) Pub. Date: Mar. 14, 2002

(54) User selection and authentication process over secure and nonsecure channels

(76) Inventor: Larry Lee Hines, Santa Clara, CA (US)

Correspondence Address: OPPENHEIMER WOLFF & DONNELLY, P. O. BOX 10356, PALO ALTO, CA, 94303, US

(21) Appl. No.: 09/942,072

(22) Filed: Aug. 28, 2001

Related U.S. Application Data
(60) Provisional application No. 60/231,722, filed on Sep. 8, 2000.

(51) Int. Cl. H04K 1/00; H04L 9/00

(52) U.S. Cl. 380/247; 713/168

(57) ABSTRACT

A system for providing and authenticating a personal identification number (PIN) or password over a network, comprising: a user device; a first server, coupled to the user device, for encrypting and decrypting enrollment information, the information comprising an enrollment request and an enrollment applet; a second server, coupled to the user device, for encrypting and decrypting authorization information, the authorization information comprising a PIN code or password and authentication data; a host application, coupled to the first server and the second server, for verifying and transmitting authorization information and enrollment information; a first secure connection for coupling the first server and the user device; a second secure connection for coupling the second server and the user device; and a customer applet, transmitted from the host application to the user device over the first secure connection, for allowing a user to enter enrollment information comprising a PIN code or password.

### RELATED APPLICATIONS

This application claims the benefit of U.S. Provisional Application Serial No. 60/231,722, entitled, “USER SELECTION ARCHITECTURES AND AUTHENTICATION PROCESS OVER SECURE AND NONSECURE CHANNELS” filed on Sep. 8, 2000, which is hereby incorporated herein by reference.

### BACKGROUND OF THE INVENTION

1. Field of the Invention

The present invention relates to a method and apparatus for secure and reliable electronic data transfer. More particularly, but without limitation, the present invention relates to the selection and authentication of data such as personal identification number codes (PIN codes) and passwords over a network such as the Internet.

2. Description of the Related Art

Reliable electronic data transfer is highly useful in many situations. For example, the banking industry requires identification of automatic teller machine (“ATM”) customers using security devices, typically banking cards. Various other types of security measures, for example those which grant or deny access to a building through an entry door, also rely upon identification of a card holder, frequently requiring the card holder to be in possession of a personal identification number (“PIN”).

Organizations are always seeking additional avenues to gain exposure for their products. Extra exposure translates into additional sales. The incredible growth of the Internet has provided companies and organizations with an exponential increase in exposure and has essentially changed the way many organizations do business. However, with such a boom comes an increase in the amount of fraud, and therefore security becomes a big issue. Consumers desire a certain comfort level such that when they purchase a product or exchange information over a network such as the Internet, the information they provide cannot be illegally obtained and improperly used.

There are methods currently available for verifying and authenticating data in an off-line or out-of-band computer environment. One such method is described in U.S. Pat. No. 5,757,918 entitled “METHOD AND APPARATUS FOR USER SECURITY DEVICE AUTHENTICATION” to Hopkins, which is incorporated herein by reference in its entirety. However, it is desirable to provide a system and method for allowing a user to select and authenticate a password or a PIN code over a network such as the Internet. Such a system would allow for quick and easy transactions without the need for waiting for the PIN code or password to be sent via another medium, while at the same time maintaining a substantial level of security.

### SUMMARY OF THE INVENTION

The present invention provides a method and apparatus for providing, selecting and authenticating data on a network. Specifically, a method and apparatus is described for providing, selecting and authenticating such data between a user computer and a host application through a plurality of intermediary servers. One embodiment of the present invention provides a method of providing and authenticating secure data over a network, comprising: establishing a first secure connection from a user device to a first server; encrypting an enrollment request with a first authentication key, and thereafter sending the encrypted enrollment request to a host application; encrypting an enrollment applet, a public key and signed data with the first authentication key and thereafter returning the encrypted enrollment applet, public key and signed data from the host application to the first server; decrypting the enrollment applet and sending the enrollment applet from the first server to the user device using the first secure connection; establishing a second secure connection from the user device to a second server; encrypting the secure data with the public key using the enrollment applet; linking the signed data and the encrypted secure data and thereafter sending the linked data to the second server; encrypting the linked data with a second authentication key and sending the encrypted linked data to the host application; verifying the signed data and thereafter creating authentication data; encrypting the authentication data and the secure data and sending the encrypted authentication data and secure data to the second server; storing the encrypted authentication data and the secure data in the enrollment applet.

Another embodiment of the present invention provides a system for providing and authenticating an access code over a network, comprising: a user device; a first server, coupled to the user device, for encrypting and decrypting enrollment information, the information comprising an enrollment request and an enrollment applet; a second server, coupled to the user device, for encrypting and decrypting authorization information, the authorization information comprising an access code and authentication data; a host application, coupled to the first server and the second server, for verifying and transmitting authorization information and enrollment information; a first secure connection for coupling the first server and the user device; a second secure connection for coupling the second server and the user device; and a customer applet, transmitted from the host application to the user device over the first secure connection, for allowing a user to enter enrollment information comprising an access code.

In accordance with one embodiment, a first secure connection is established between a user computer and an intermediary first server. The user requests enrollment, which in turn results in the first server encrypting the enrollment request and transmitting it to the host application. The host application returns an applet, a public key, a serial number and an account number to be used for selection of a PIN code or password. The first server decrypts the information from the host application and sends an enrollment applet to the user via the first secure connection.

The user then fills out the enrollment information and thereafter the enrollment applet residing on the user's computer connects or “redirects” the user to an intermediary second server using a second secure connection. The user then enters the PIN code or password, which the enrollment applet encrypts with the public key. The enrollment applet then combines the encrypted PIN code or password with the serial number and account number that identifies the user and sends it to the second server. The second sever encrypts the serial number, account number and encrypted PIN code or password and subsequently transmits it to the host application.

The host application verifies the account number and serial number. If the information is correct, the host application creates authentication data, which is encrypted along with the selected PIN code or password and sent to the second server along with a public exponent and modulus. The second server then sends the authentication data, the public exponent and the modulus to the authentication applet. The authentication applet stores a copy of the information to be used with subsequent logons.

### BRIEF DESCRIPTION OF THE DRAWINGS

FIG. 1 is a diagram of a prior art method for transmitting authentication data in an on-line environment;

FIG. 2 is a diagram of a system and method for providing authentication data such as PIN code or password in a non-secure network environment in accordance with one embodiment of the present invention;

FIG. 3 is a schematic block diagram generally illustrating further details of either the first server or the second server of FIG. 2;

FIGS. 4-7 are flowcharts detailing the provision of a password or PIN code in a non-secure network environment in accordance with one embodiment of the present invention;

FIG. 8 illustrates the logon/authentication process using the data provided in the network environment of FIG. 2; and

FIGS. 9-10 are flowcharts detailing the logon/authentication procedure in accordance with one embodiment of the present invention.

### DESCRIPTION OF THE SPECIFIC EMBODIMENTS

The following description is of the best presently contemplated modes of carrying out the invention. The description is made for the purpose of illustrating the general principles of the invention and is not to be taken in a limiting sense.

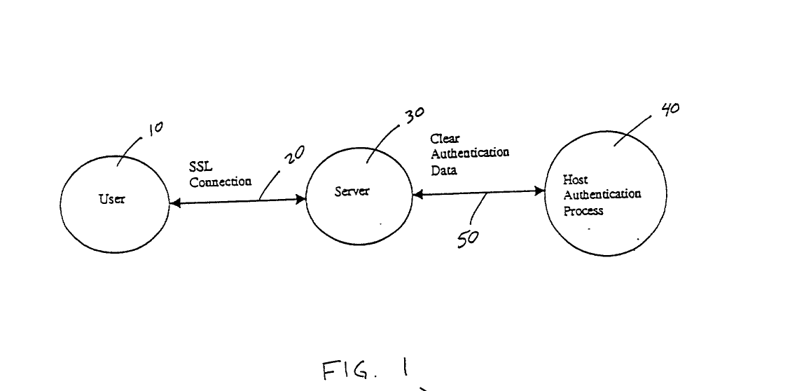

FIG. 1 illustrates one example of a prior art system and method for providing security for the selection of a user's authentication data. As shown in the Figure, user 10 connects to a server 30 using a secure connection. The secure connection can be an SSL connection as illustrated or any other connection that provides a secure method of transmitting and receiving data from user 10 to server 30. Server 30 connects to host authentication process 40 using connection 50. Connection 50 typically is not a secure connection. Authentication data is then transmitted over connection 50 from host authentication process 40 to server 30, then from server 30 to user 10 over secure connection 20.

The problem with the example shown in FIG. 1 is that all the exchanged information is created at the host application 40 or the user 10 without any steps for authenticating the identity of either party. Without having a means for identifying that one side of the process cannot produce so the other side of the process can verify, the authentication process essentially gives all the necessary tools to carry out a fraudulent act by illegally obtaining the authentication data. Moreover, the system is highly vulnerable to insider attacks since the authentication data is not kept private and secure.

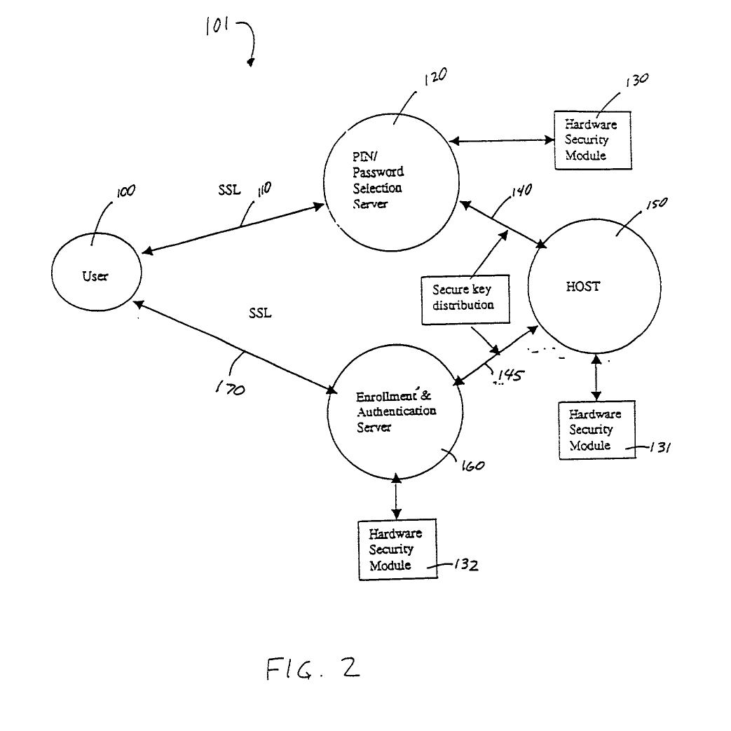

Referring now to FIG. 2, one embodiment of a network environment 101 in accordance with the present invention is illustrated. As shown in this Figure, user 100 is connected to a first server 120 by a first secure connection 110. In the illustrated embodiment, user 100 can be a personal digital assistant (PDA), personal computer (PC) or any similar device for connecting and allowing interaction between a user 100 and a network environment. Similarly, user 100 is connected to a second server 160 by a second secure connection 170. First secure connection 120 and second secure connection 160 may be a secure sockets layer (SSL) as illustrated for encrypting and transporting private data over the Internet. However, as one skilled in the art can appreciate, first secure connection 120 and second secure connection 160 may be any secure connection for encrypting and transporting private data in a network environment, such as Secure HTTP (S-HTTP), Internet Protocol Security (IPSEC) or the like.

In the illustrated embodiment, first server 120 operates as a PIN code or password selection server, whereas, second server 160 operates as an enrollment and authentication server. Each server has coupled thereto a respective hardware security module 130, 132. Hardware security modules 130, 132 provide the necessary public key cryptography. Although an embodiment of the invention is described in terms of public key cryptography, public key technology is only one form of asymmetric cryptography, and as such, any form of asymmetric or symmetric cryptography can be substituted without deviating from the intent of the invention. The cryptography can reside in a hardware add-on as shown, such as an AXL200 PCI accelerator card manufactured by Compaq Computer Corporation of Houston Tex., or the equivalent, or it could simply be a set of functions operating as an application located within first server 120 and second server 160.

Further illustrated in FIG. 2, first server 120 is coupled to host application 150 by first connection 140, and second server 160 is coupled to host application 150 by a second connection 145. Unlike the connections between the user and the first and second servers, first connection 140 and second connection 145 are typically not secure connections. Host application 150 has a hardware security module 131 coupled thereto, which is similar to hardware security modules 130, 132 described previously. Authorization host application 150 is typically an application residing on a server, however as one skilled in the art can appreciate, host application 150 can be anything that allows for easy storage and retrieval of customer information.

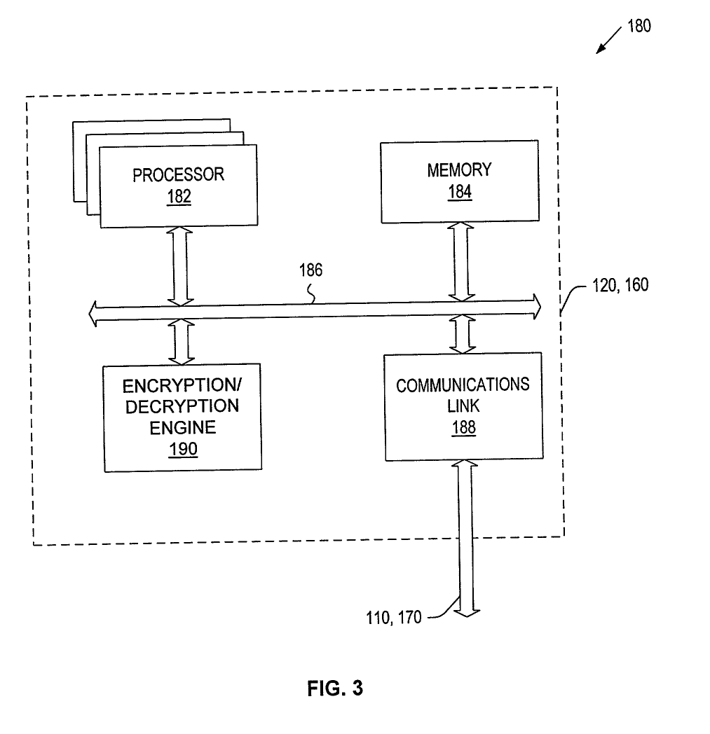

FIG. 3 shows a schematic block diagram generally illustrating further details at 180 of either the first server 120 or the second server 160 of the network 101 (FIG. 2) in accordance with the present invention. As shown in this Figure, the server 120, 160 includes: at least one processor 182 for executing computer readable instructions; a memory 184 communicatively coupled with the processor 182 via a bus 186; a communications link 188 for communicating with other computer systems; and an encryption/decryption engine 190 for encrypting and decrypting data.

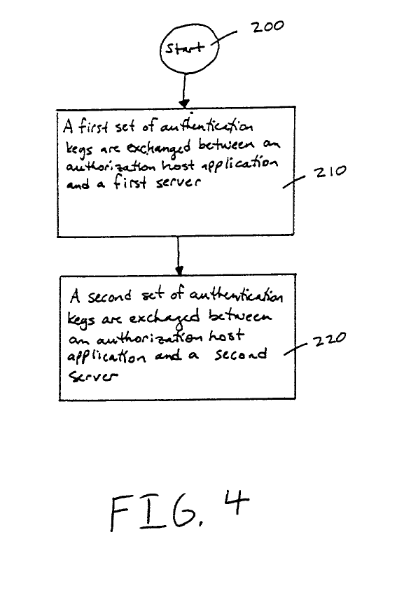

Referring now to FIG. 4, network system 101 is initialized prior to any exchange of data or information, as shown in step 200. After system initialization, a first set of authentication keys are exchanged between the first server 120 and the host application 150, as illustrated in step 210. The first set of authentication keys are used to share and verify secret data transferred between the first server and the host application as part of the enrollment selection process. In addition, but not necessarily in any particular order, a second set of authentication keys are exchanged between an authorization host application and the second server, as shown in step 220. The second set of keys are used to authenticate data transferred between the second server and the host application.

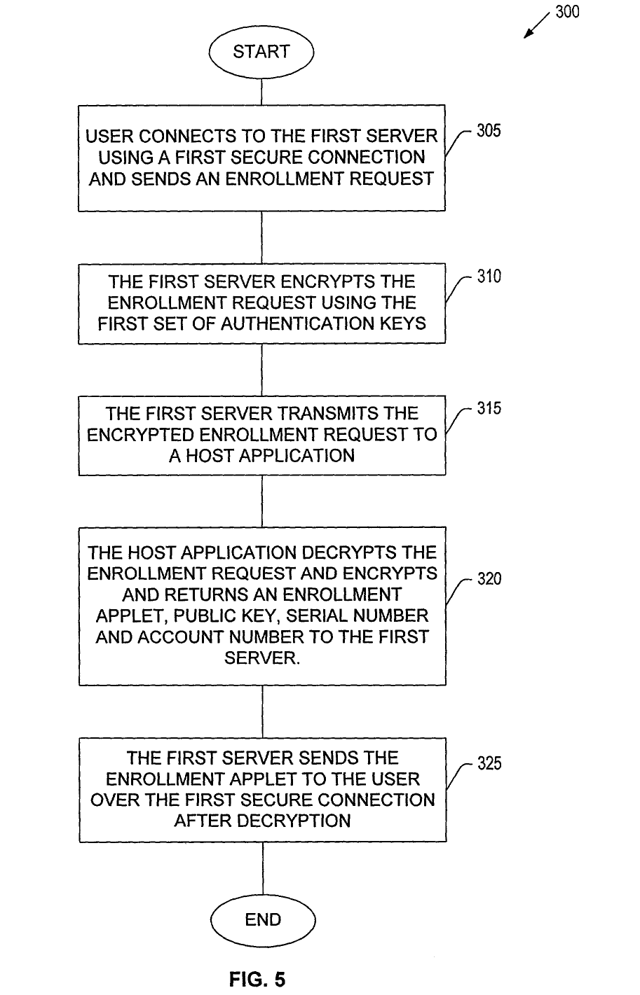

Referring now to FIG. 5 illustrating a process at 300, user 100 connects to a first server 120, or an enrollment and authentication server, by a first secure connection 110 and sends an enrollment request, as shown in step 305. In step 310, the first server 120 encrypts the enrollment request using a first set of authentication keys. Thereafter, the first server 120 transmits the enrollment request to a host application 150 over a second connection 140, as illustrated in step 315. As shown in step 320, the host application 150 decrypts the enrollment request and subsequently encrypts and returns an enrollment applet, public key, serial number and account number to the first server. The combination of a serial number and an account number is also referred to as signed data. The information is to be used for the selection of an access code such as a PIN code or password by user 100. In addition, the encryption is done at host application 150 with the first set of authentication keys. In step 325, the first server sends the enrollment applet to the user 100 after decryption using the first secure connection 110.

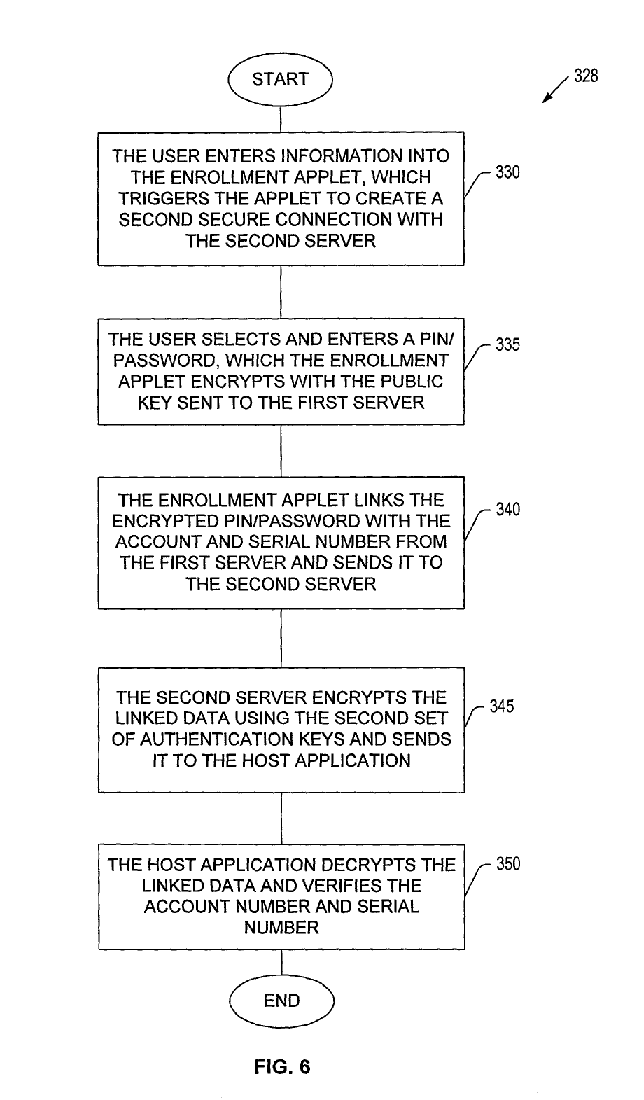

FIG. 6 illustrates a process at 328 for verifying an account number and serial number in accordance with one embodiment of the present invention. In FIG. 6, user 100 enters information into the enrollment applet, as shown in step 330. The enrollment applet thereafter creates a second secure connection 170 between the user 100 and the second server 160. User 100 selects and enters a PIN code or password, into the enrollment applet, which the enrollment applet encrypts with the public key that was sent to the first server 120. The enrollment applet then links the encrypted PIN code or password with the account number and serial number that was received from the first server and sends the linked data to the second server or the enrollment and authorization server 160 over the second secure connection 170. The second server 160 encrypts the linked data using the second set of authentication keys and thereafter sends the encrypted linked data over connection 145 to the host application 150, as shown in step 345. In step 350, the host application 150 decrypts the linked data and verifies the account number and the serial number. Each of the encryption and decryption steps are performed by the encryption/decryption engine 190 (FIG. 3).

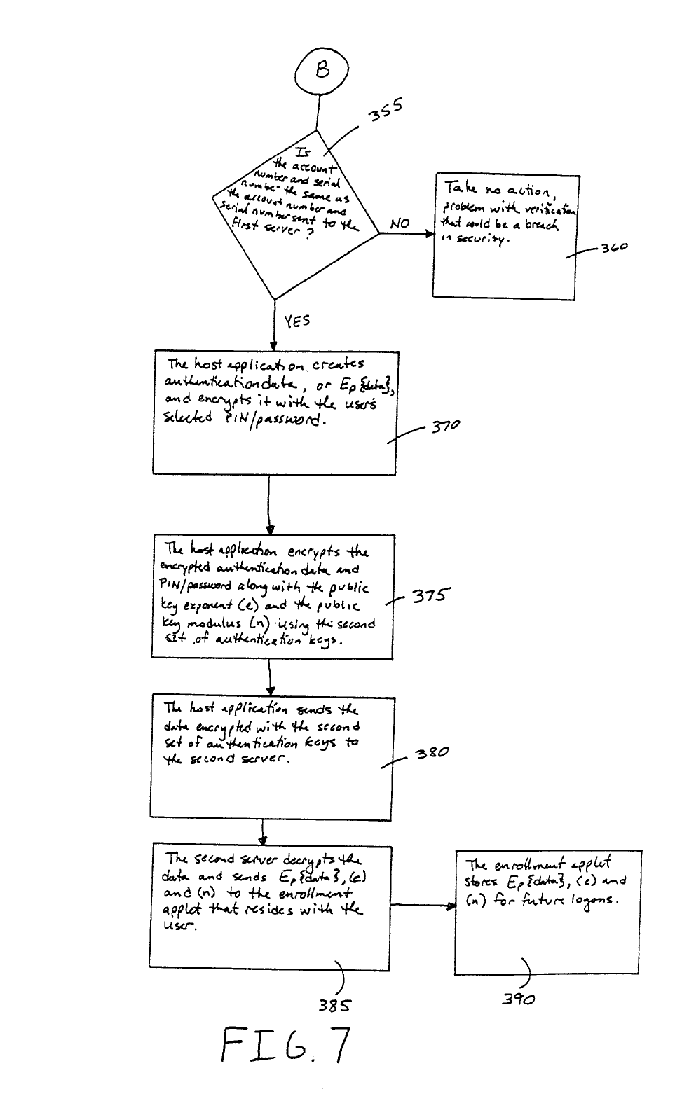

Referring now to FIG. 7, the host application 150 makes the determination of whether the account number and serial number are the same as the account number and serial number that were transferred to the first server 120. If the numbers do not match, there is a possible security breach and the process is aborted, as shown in step 360. In addition, notification may be sent to a host administrator allowing for appropriate action to be taken. Moreover, a notification may be sent to the user to inform him or her about a possible security problem.

As shown in step 370, if the account numbers and serial numbers match, the host application 150 creates authentication data, defined in the illustrated embodiment as Eₚ {data}. The authentication data is thereafter encrypted with the user's selected PIN code or password. In step 375, host application 150 encrypts the encrypted authentication data and PIN code or password described in step 370 along with the public key exponent (e) and the public key modulus (n) using the second set of authentication keys. Host application 150 sends the encrypted data to the second server 160 over connection 145.

Illustrated in step 385, the second server 160 decrypts the data and subsequently sends the authentication data Eₚ {data}, the public key exponent (e) and the public key modulus (n) to the enrollment applet that resides with the user 100. The enrollment applet stores Eₚ {data}, the public key exponent (e) and the public key modulus (n) for future logons. With the transmission and storing of this data at the user's location 100, the chosen PIN code or password never has to enter the network environment in any subsequent networking sessions.

In an alternative embodiment, the authentication data Eₚ {data}, the public key exponent (e) and the public key modulus (n) are stored on a smart card (not shown) at location 100. The smart card may be removed from location 100, and may be used to access public network accessing devices (not shown) at any location. This would allow a user to access an account at any network accessing device equipped to read a smart card. A user would simply have to swipe his smart card through the network accessing device, and enter his PIN code and password in order to access the account. Alternatively, the PIN may also be stored on the smart card, requiring the user only to enter his password. This would only require a user to remember a single password in order to access his account at a public device.

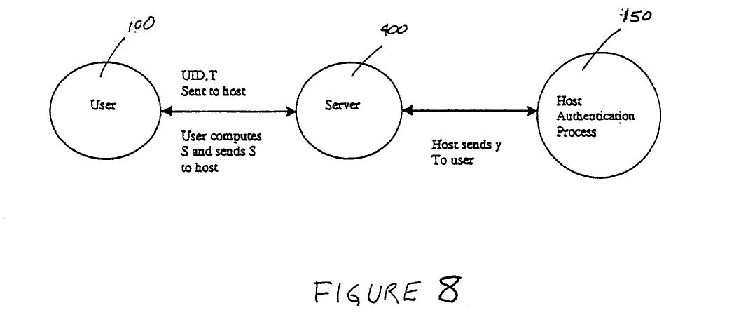

Referring now to FIG. 8, the data provided in the network environment previously described is used for a subsequent logon event by the user, which is illustrated in a typical network configuration. In an embodiment, in a subsequent logon, user 100 communicates with the host application 150, or host authentication process, through server 400.

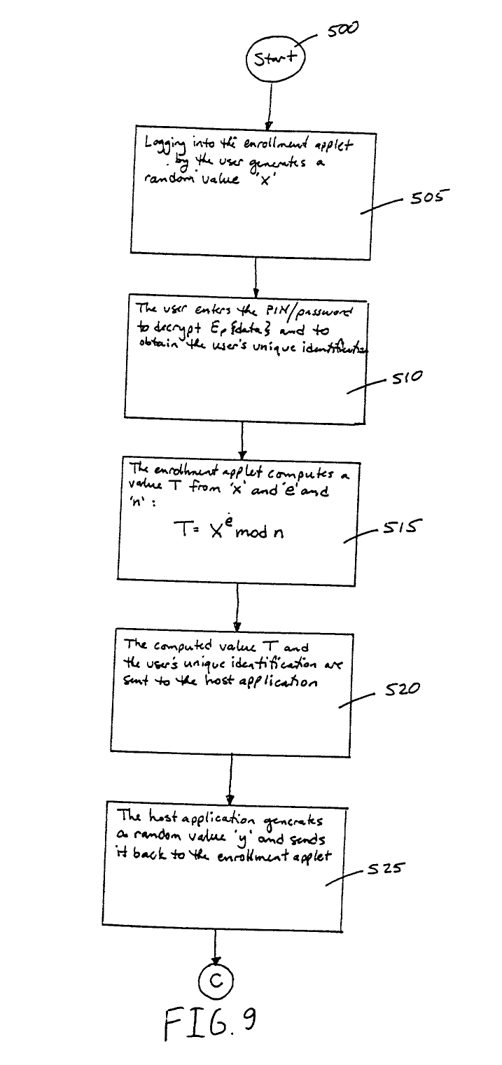

In FIG. 9, the user 100 logons on to the applet, which generates a random value ‘x’, as shown in step 505. In step 510, the user enters the PIN code or password to decrypt the Eₚ {data} and the user's unique identification number. As illustrated in step 515, the enrollment applet computes a value ‘T’ using ‘x’, ‘e’ and ‘n’ using the following equation:

T=X^{e} mod n

The compute value of ‘T’ and the user's unique identification are thereafter sent to the host application 150.

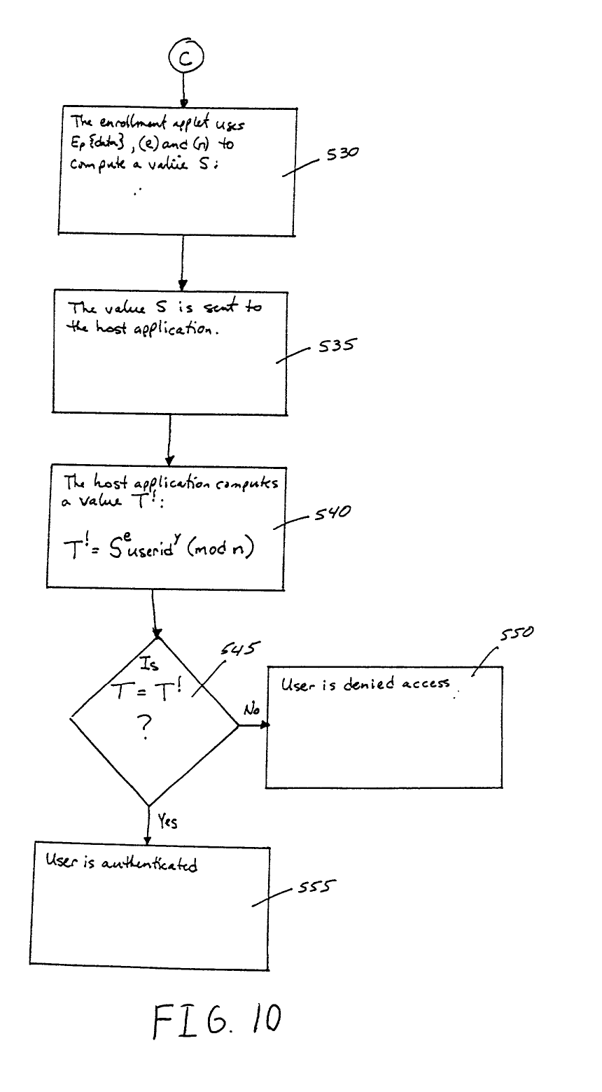

In response, as shown in step 525, the host application 150 generates a random value ‘y’. The value ‘y’ is sent to the enrollment applet, as shown in step 525. As illustrated in FIG. 10, the enrollment applet computes a value S using Eₚ {data}, ‘e’ and ‘n’ using the methodology disclosed in U.S. Pat. No. 5,757,918 entitled “METHOD AND APPARATUS FOR USER SECURITY DEVICE AUTHENTICATION” to Hopkins. As shown in step 535, the resulting value of ‘S’ is sent to the host application 150. The host application 150 now has the necessary data to authenticate the user. As shown instep 540, the host application 150 computes a value ‘T’ using the following equation:

T^{!}=S^{e} userid^{y} (mod n)

Referring further to FIG. 10, the values of ‘T’ and T^{!} are compared to determine if the values are equal. If the values are different, user 100 is denied access. However, if the values are the same, the user is authenticated and allowed to proceed with the session, as shown in step 555.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. For example, the invention does not necessarily have to be used with PIN codes or passwords. The disclosed invention could also be used for the transmission of pass keys, either symmetric or asymmetric, to an application, changing PIN codes or passwords or any other transmission of secret data that requires a heightened level of security. As a further example, an embodiment of the invention may reside on an integrated circuit card.

What is claimed is:

1. A method of providing and authenticating secure data over a network, comprising:
establishing a first secure connection from a user device to a first server;
encrypting an enrollment request with a first authentication key, and thereafter sending the encrypted enrollment request to a host application;
encrypting an enrollment applet, a public key and signed data with the first authentication key and thereafter returning the encrypted enrollment applet, public key and signed data from the host application to the first server;
decrypting the enrollment applet and sending the enrollment applet from the first server to the user device using the first secure connection;
establishing a second secure connection from the user device to a second server;
encrypting the secure data with the public key using the enrollment applet;
linking the signed data and the encrypted secure data and thereafter sending the linked data to the second server;
encrypting the linked data with a second authentication key and sending the encrypted linked data to the host application;
verifying the signed data and thereafter creating authentication data;
encrypting the authentication data and the secure data and sending the encrypted authentication data and secure data to the second server;
storing the encrypted authentication data and the secure data.

2. The method of claim 1, wherein the signed data comprises a serial number and an account number.

3. The method of claim 1, further comprising exchanging the first authentication key between the first server and the host application and exchanging the second authentication key between the second server and the host application.

4. The method of claim 1, wherein storing the encrypted authentication data and the secure data includes storing at least a portion of the authentication data and the secure data in the enrollment applet.

5. The method of claim 1, wherein storing the encrypted authentication data and the secure data includes storing at least a portion of the authentication data and the secure data in a mobile storage medium.

6. The method of claim 5, wherein the mobile storage medium is a smart card device which may be used to access an account from at least one remote location.

7. A method of providing and authenticating secret data over a network, the network comprising a user device, a first server, a second server and a host application, comprising: establishing a first secure connection between the user device and the first server in response to an enrollment request from a user;
sending encrypted enrollment information from the host application to the first server;
decrypting the enrollment information at the first server;
sending an enrollment applet and a unique identifier from the first server to the user device, the unique identifier identifies the user device;
establishing a second secure connection between the user device and the second server;
encrypting an access code using the customer applet;
linking the encrypted access code with the unique identifier and thereafter sending the linked encrypted access code and the unique identifier to the second server;
encrypting the linked data at the second server and thereafter sending the encrypted linked data to the host application;
verifying the unique identifier at the host application and thereafter creating authentication data;
encrypting the authentication data with the access code;
sending the encrypted authentication data and access code from the host application to the second server;
sending the encrypted authentication data and access code from the second server to the customer applet using the second secure connection; and
storing the encrypted authentication data and access code in the customer applet.

8. The method of claim 7, wherein the access code is a personal identification number (PIN).

9. The method of claim 7, wherein the access code is a password.

10. The method of claim 7, wherein storing the encrypted authentication data and access code includes storing at least a portion of the encrypted authentication data and the access code in the customer applet.

11. The method of claim 10, further comprising:
encrypting and sending an enrollment applet, a public key, a serial number and an account number from the host to the first server; and
decrypting the enrollment applet, a public key, a serial number and an account number at the first server.

12. The method of claim 7, wherein storing the encrypted authentication data and access code includes storing at least a portion of the encrypted authentication data and the access code on a mobile storage medium.

13. The method of claim 12, wherein the mobile storage medium is a smart card device which may be used to access an account from at least one remote location.

14. A method of providing and authenticating an access code, comprising:
establishing a first secure connection from a user to a first server;
sending an enrollment request from the user to the first server using the first secure connection;
encrypting the enrollment request at the first server and thereafter sending the encrypted enrollment request to a host application;
sending encrypted enrollment information from the host application to the first server, the enrollment information comprising a customer applet, a public key, a serial number and an account number, wherein the information is used for enrolling and selecting the access code by the user;
decrypting the customer applet at the first server and thereafter sending the customer applet over the first secure connection to the user;
establishing a second secure connection from the user to a second server using the customer applet;
selecting the access code by;
encrypting the access code with the public key using the customer applet;
linking the encrypted access code with the account number and the serial number from the first server and thereafter sending the linked data to the second server;
encrypting the linked data at the second server and thereafter sending the encrypted linked data to the host application;
verifying the account number and the serial number at the host application and thereafter creating authentication data;
encrypting the authentication data and the access code;
sending the encrypted authentication data and access code from the host application to the second server;
sending the encrypted authentication data and access code from the second server to the customer applet using the second secure connection; and
storing the encrypted authentication data and access code.

15. The method of claim 14, wherein storing the encrypted authentication data and access code includes storing at least a portion of the authentication data and the access code in the customer applet.

16. The method of claim 14, wherein storing the encrypted authentication data and access code includes storing at least a portion of the authentication data and the access code on a mobile storage medium.

17. The method of claim 16, wherein the mobile storage medium is a smart card device which may be used to access an account from at least one remote location.

18. A system for providing and authenticating an access code over a network, comprising:
a user device;
a first server, coupled to the user device, for encrypting and decrypting enrollment information, the information comprising an enrollment request and an enrollment applet;
a second server, coupled to the user device, for encrypting and decrypting authorization information, the authorization information comprising an access code and authentication data;
a host application, coupled to the first server and the second server, for verifying and transmitting authorization information and enrollment information;
a first secure connection for coupling the first server and the user device;
a second secure connection for coupling the second server and the user device; and
a customer applet, transmitted from the host application to the user device over the first secure connection, for allowing a user to enter enrollment information comprising an access code.

19. The system of claim 18, wherein the first and second secure connections are SSL connections.

20. The system of claim 18, wherein the customer applet establishes the second secure connection in response to a user entering enrollment information.

21. The system of claim 18, further comprising a plurality of hardware service modules, one each coupled to the first server, the second server and the host application, for performing cryptography.

22. The system of claim 18, wherein the user device comprises a personal digital assistant.

23. The system of claim 18, wherein the user device comprises a personal computer.

24. The system of claim 18, wherein at least a portion of the customer applet is stored on a smart card device, wherein the smart card device may be used to access an account from at least one remote location.

25. The system of claim 18, wherein the access code is a personal identification number (PIN).

26. The system of claim 18, wherein the access code is a password.
